(19) United States
(12) Patent Application Publication
(10) Pub. No.: US 2009/0082574 A1
(43) Pub. Date: Mar. 26, 2009

(54) Metallacycles and methods of making the same

(75) Inventors: Kuang-Lieh Lu, Taipei (TW); Malaichamy Sathiyendiran, Tamilnadu (IN); Chung-Chou Lee, Geishan Township (TW); Che-Hao Chang, Longjing Township (TW); Tien-Wen Tseng, Taipei (TW); Shie-Ming Peng, Taipei (TW); Gene-Hsiang Lee, Taipei (TW)

Correspondence Address: COHEN, PONTANI, LIEBERMAN & PAVANE LLP, 551 FIFTH AVENUE, SUITE 1210, NEW YORK, NY, 10176, US

(73) Assignee: Academia Sinica, Nankang Taipei (TW)

(21) Appl. No.: 12/283,468

(22) Filed: Sep. 12, 2008

Related U.S. Application Data
(60) Provisional application No. 60/993,351, filed on Sep. 12, 2007.

(51) Int. Cl. C07F 13/00

(52) U.S. Cl. 548/108

(57) ABSTRACT

The present invention provides for novel metallacycles and processes for making the same.

### RELATED APPLICATIONS

This application claims priority from U.S. Provisional Patent Application Ser. No. 60/993,351 which was filed on Sep. 12, 2007.

### BACKGROUND OF THE INVENTION

### 1. Field of the Invention

The design of molecular containers represents an important component of nanotechnology and has attracted intense interest from synthetic chemists. Research on molecular containers, in particular bowl-shaped molecules, can realistically be expected to provide highly selective sensors, stabilize reactive intermediates, and catalyze chemical transformations within their “microreactoc” cage-like structures. Several general synthetic approaches toward the preparation of metallacycles emerged, which include directional-bonding, symmetric interactions, and weak-link approach. Of the available methods, synthesis of neutral metallacycles in one-step with wide-enough cavities to accommodate guest molecules is scarcely known. Hence, it is desirable to design a new approach to neutral metallacycles.

Large cavity-containing metallacycles are currently attracting a great deal of attention because of their potential applications in separation materials, as components in nanoelectronics, and as recognition elements in chemical and biological sensors. Recent emphasis in this field has been directed to the design of functional metallacycles with unusual molecular sensing or catalytic properties. Examples include the development of fluorescent sensors and allosteric catalysts that mimic the properties of allosteric enzymes.

Tuning the topology of supramolecular entities is a major challenge in a successful self-assembly process. The primary factors that control the self-assembly of metallacycles are the bonding mode and shape of the ligand and the metal ion coordination preference. The use of a flexible motif is less common in the self-assembly of metallacycles, and only a handful of examples has been reported. Incorporating a flexible unit offers several potential advantages such as breathing ability in the solid-state and adaptive recognition properties as a function of coexisting guests in supramolecular systems. Flexible organic components are generally less predictable during self-assembly and have a tendency to generate [2]-catenanes or oligomers upon reaction with metal ions. They frequently require guest molecules acting as templates in order to form discrete structures.

### SUMMARY OF THE INVENTION

We discovered the new approach i.e., orthogonal-bonding approach, to synthesis cage- to prismatic-supramolecules. This approach involves the simultaneous introduction of a bis(chelating) dianion to coordinate to two equatorial sites of fac-(CO)₃M cores and a nitrogen donor ligand from bidentate to polydentate to the remaining orthogonal axial site.

The invention is based on the discovery of eight new classes of supramolecules having cage-like and prismatic structures. The new supramolecules are neutral, possess wide-enough cavity, and functional groups, and can be prepared by a one-pot synthesis via orthogonal-bonding approach.

As a specific embodiment, the present invention provides a unique rigidity-modulated conformation control strategy for incorporating flexible building motifs into Re-based metallacycles. The metallacycles were prepared, without a template, using flexible and rigid building blocks in a one-step self-assembly reaction. We demonstrate how the conformation of the flexible unit can be directed by a rigid linker with an appropriate length thereby altering the M . . . M separation which, together, direct the geometry of the final structures.

The results as disclosed in the Examples indicate that the rigid anionic linker responsible for determining M . . . M separation, provides the potential for directing the conformation of the flexible motif during the self-assembly of metallacycles. This rigidity-modulated conformation control approach is so effective that the geometry of Re-based metallacycles can be easily tuned when both flexible and rigid ligands are used as building units. To the best of our knowledge, this is the first report on the conformation control of a flexible building unit by a rigid motif in the self-assembly of metallacycles.

In one aspect, this invention features a gondola-type supramolecule having structure I via orthogonal-bonding approach:

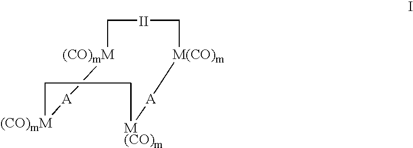

M is a transition metal atom that is rhenium (Re), manganese (Mn), chromium (Cr), molybdenum (Mo), tungsten (W), iron (Fe), ruthenium (Ru), or osmium (Os); Π is a nitrogen based bidentate clip; A is a dianionic bischelating-bridging unit. Other transition metal atoms may be utilized in accordance with the present invention as long as they, together with ligands, can form a coordination complex having the gondola structures.

As used herein, the “orthogonal-bonding approach” to gondola structure refers to the simultaneous introduction of a bis(chelating) dianion to coordinate to two equatorial sites of fac-(CO)₃M cores and a bidentate nitrogen donor clip i.e., parallel coordination mode, to the remaining orthogonal axial site.

As used herein, the term “gondola” refers to a compound having four transition metal atoms connected in a gondola-like shape. Each of the metal atoms occupies one corner or middle of the bottom of the gondola and is bonded to one nitrogen of a nitrogen-based bidentate clip, i.e., Π in structure (I) and is chelated to two oxygen atoms or two nitrogen atoms of a nitrogen- or oxygen-based bis(chelating) ligand, i.e., A in structure (I).

A “nitrogen-based bidentate clip ligand” refers to a ligand that is bonded to two transition metal atoms in a parallel fashion, and includes one or more heterocyclic or heteroaryl groups (e.g., oxazole, imidazole, pyridine) having one or more nitrogen atoms.

Referring to structure I, a subset of gondola-shaped supramolecules of this invention are those in which M is Re; m is 3; A is dianionic bis(chelating) ligand; n is oxazole-based ligand or a ligand with the following formula:

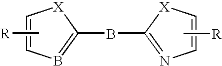

In the formula, B is heterocyclyl, aryl and x is O, S or NH; R is alkyl, cyclyl, aryl. Additional examples of Π are shown below:

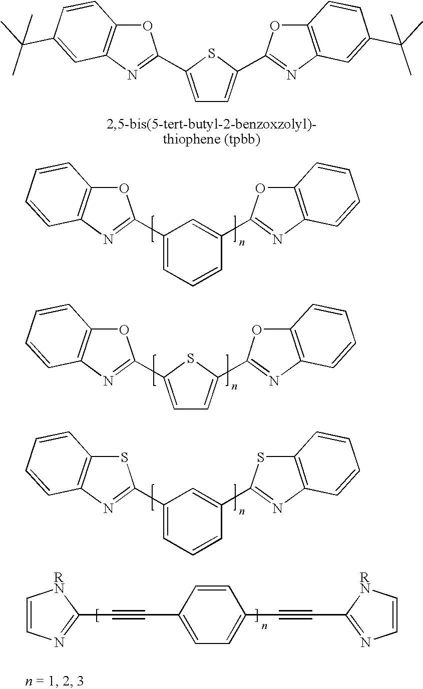

Referring to structure I, A is a nitrogen- or oxygen-based bis(chelating) dianionic ligand or a ligand of the formula:

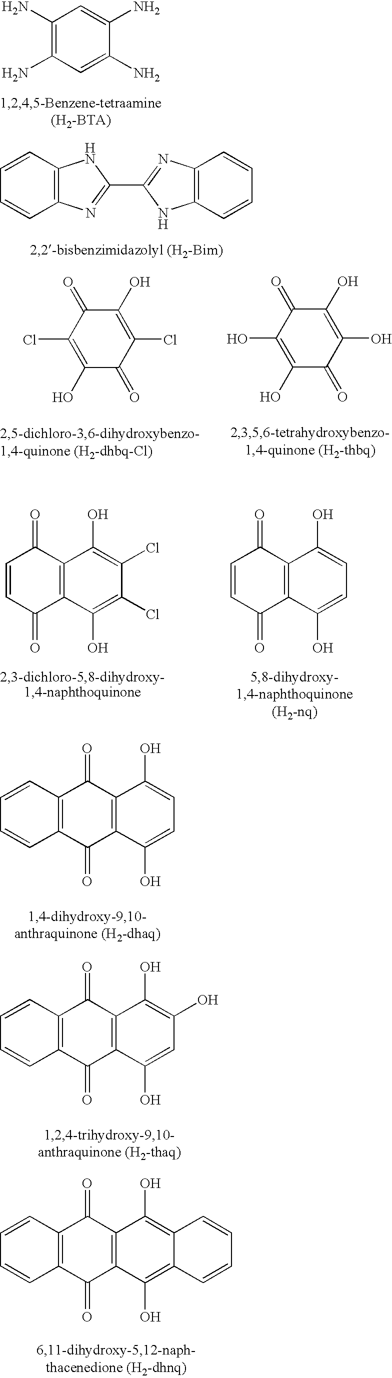

(referred to herein after as “H₂-dhbc”, “H₂-Bim”, “H₂-BTA”, “H₂-dhnd”, “H₂-dhaq”, “H₂-thaq”, “H₂-dhnq”, respectively).

In another aspect, this invention features a calix-shaped supramolecules having the structure (II):

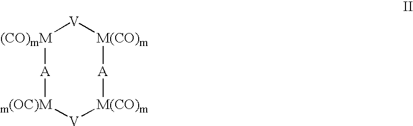

M is a transition metal atom that is rhenium (Re), manganese (Mn), chromium (Cr), molybdenum (Mo), tungsten (W), iron (Fe), ruthenium (Ru), or osmium (Os); V is a nitrogen based bidentate ligand having 60° bite angle; A is a bischelating-bridging unit. Other transition metal atoms may be utilized in accordance with the present invention as long as they, together with ligands, can form coordination complexes having the calix-shaped bowl structures.

As used herein, the “orthogonal-bonding approach” to calix-shaped bowl structure refers to the simultaneous introduction of a bischelating dianion (A) to coordinate to two equatorial sites of fac-(CO)₃M cores and a bidentate ligand possessing 60° bite angle i.e., 60° between two coordinating nitrogen atoms, to the remaining orthogonal axial sites.

As used herein, the term “calix” refers to a compound having four transition metal atoms connected in calix geometry. Each of the transition metal atoms occupies one corner of the bowl, and is bonded to one nitrogen atom of a nitrogen-based ligand and is chelated to two oxygen atoms or two nitrogen atoms or a nitrogen- and a oxygen-based bischelating ligand.

A “nitrogen-based bidentate ligand” refers to a ligand that is bonded to two transition metal atoms, and includes one or more heterocyclic or heteroaryl groups having one or more nitrogen atoms.

Referring to structure (II), a subset of calix-shaped supramolecules of this invention are those in which M is Re; m can be 3; A is H₂-dhcd or H₂-Bim or H₂-BTA or H₂-dhnd or H₂-dhaq or H₂-dhnq; and V is 4,7-phenanthroline or a ligand with a formula as follows:

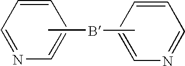

B′ is a bond, alkenyl, alkynyl, aryl, heterocyclyl, or heteroaryl; further, the two rings can be fused together with B′ (not shown).

Examples of V include

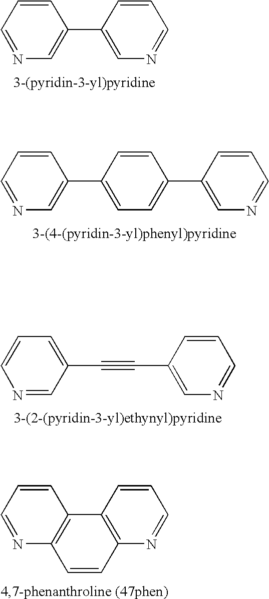

Additional examples of V are shown below:

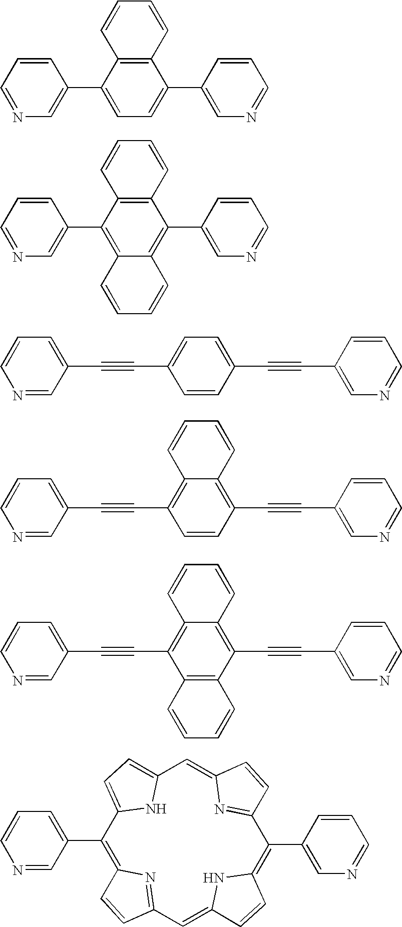

In another aspect, this invention features an octanuclear cage having structure (III):

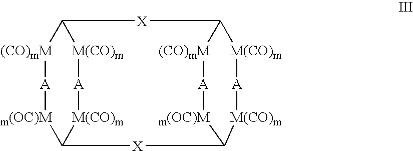

Here M is a transition metal atom that is rhenium (Re), manganese (Mn), chromium (Cr), molybdenum (Mo), tungsten (W), iron (Fe), ruthenium (Ru), or osmium (Os); X is a nitrogen based tetradentate ligand; A is a bischelating-bridging unit Other transition metal atoms may be utilized in accordance with the present invention as long as they, together with ligands, can form coordination complexes having the cage structures (III).

As used herein, the “orthogonal-bonding approach” to an octanuclear cage-shaped bowl structure refers to the simultaneous introduction of a bis(chelating) dianion to coordinate to two equatorial sites of fac-(CO)₃M cores and a tetradentate nitrogen donor ligand possessing 120° bite angle on each side i.e., 1200 between two coordinating nitrogen donor atoms, to the remaining orthogonal axial sites.

As used herein, the term “cage” refers to a compound having eight transition metal atoms connected in a cage-shape. Each of the transition metal atoms occupies one corner of the cage, and is bonded to one nitrogen atom of a nitrogen-based ligand and is chelated to two oxygen atoms or two nitrogen atom or a nitrogen- and a oxygen-based bis(chelating) ligand.

A “nitrogen-based tetradentate ligand” refers to a ligand that is bonded to four transition metal atoms, and includes one or more heterocyclic or heteroaryl groups having one or more nitrogen atoms.

Referring to structure (III), a subset of octanuclear cage supramolecules of this invention are those in which M is Re; m can be 3; A is H₂-dhcd or H₂-BTA or H₂-dhnd or H₂-dhaq or H₂-dhnq; and X is diazine or a ligand of the formula:

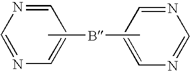

B″ is a bond, alkenyl, alkynyl, aryl, heterocyclyl, or heteroaryl.

Examples of X include

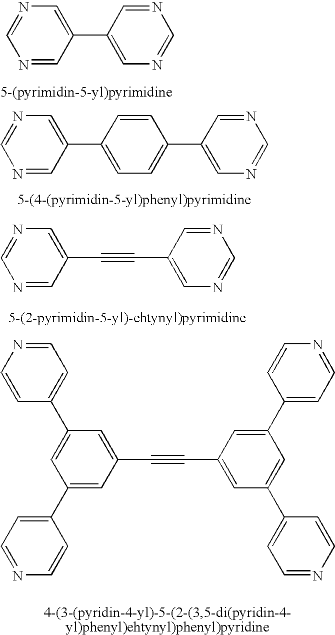

Additional examples of X are shown below:

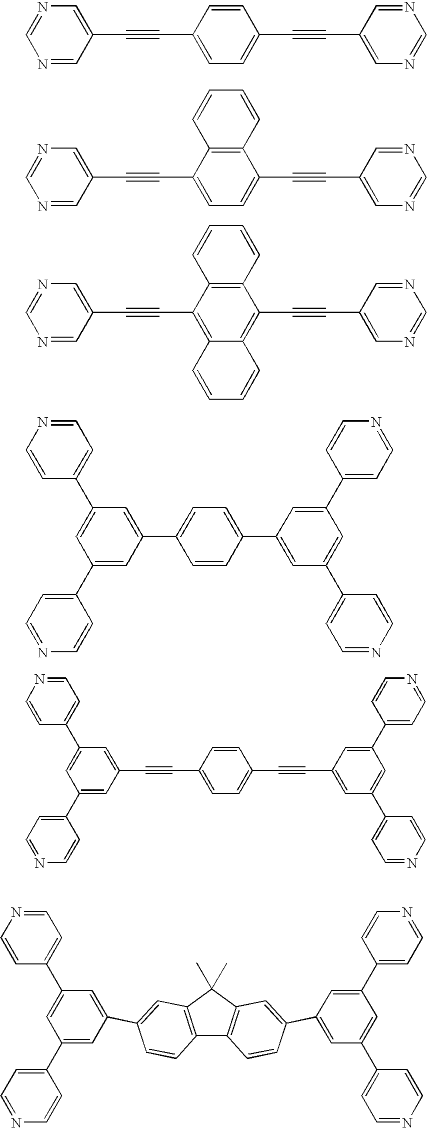

In another aspect, this invention features a dinuclear chairs having structure (IV):

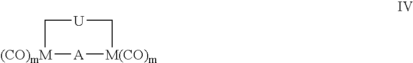

M is a transition metal atom that is rhenium (Re), manganese (Mn), chromium (Cr), molybdenum (Mo), tungsten (W), iron (Fe), ruthenium (Ru), or osmium (Os); U is a nitrogen based bidentate ligand; A is a dianionic bischelating-bridging unit. Other transition metal atoms may be utilized in accordance with the present invention as long as they, together with ligands, can form coordination complexes having the dinuclear chair-like structures of the general formula M₂AU.

As used herein, the term “chair” refers to a compound having two transition metal atoms connected in a chair-shape. Each of the transition metal atoms occupies one center-end of the bottom base, and is bonded to one nitrogen atom of a nitrogen-based ligand and is chelated to two oxygen atoms or two nitrogen atoms or a nitrogen- and a oxygen-based dianionic bis(chelating) ligand.

A “nitrogen-based bidentate ligand” refers to a ligand that is bonded to two transition metal atoms, and includes one or more heterocyclic or heteroaryl groups having one or more nitrogen atoms.

Referring to structure (IV), a subset of chair supramolecules of this invention are those in which M is Re; m can be 3; A is H₂-dhcd or H₂-BTA or H₂-dhnd or H₂-dhaq or H₂-dhnq; and U is a ligand with the following formula:

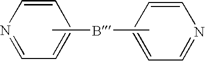

B′″ is a bond, alkenyl, alkynyl, aryl, heterocyclyl, or heteroaryl connected to at least one methylene group.

Examples of U include

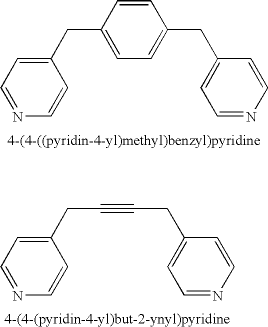

Additional examples of U are shown below:

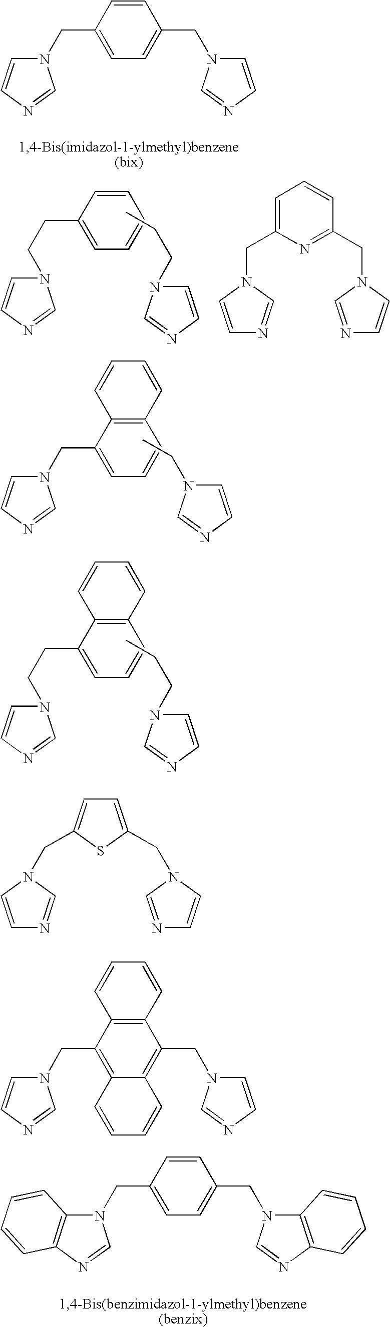

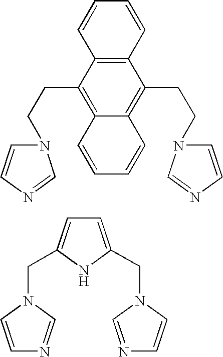

In another aspect, this invention features a rectangular supramolecule having the structure (V):

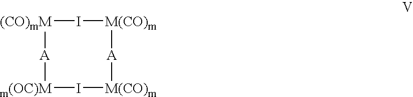

Here M is a transition metal atom that is rhenium (Re), manganese (Mn), chromium (Cr), molybdenum (Mo), tungsten (W), iron (Fe), ruthenium (Ru), or osmium (Os); I is a nitrogen based bidentate ligand having 180° bite angle; A is a dianionic bischelating-bridging unit. Other transition metal atoms may be utilized in accordance with the present invention as long as they, together with ligands, can form coordination complexes having the rectangular structures.

As used herein, the “orthogonal-bonding approach” to rectangular supramolecule structure refers to the simultaneous introduction of a bis(chelating) dianion to coordinate to two equatorial sites of fac-(CO)₃M cores and a bidentate nitrogen donor ligand possessing 180° bite angle i.e., 180° between two nitrogen donors coordinating direction, to the remaining orthogonal axial sites.

As used herein, the term “rectangular” refers to a compound having four transition metal atoms connected in a rectangular geometry. Each of the transition metal atoms occupies one corner of the rectangular, and is bonded to one nitrogen atom of a nitrogen-based ligand and is chelated to two oxygen atoms or two nitrogen atoms or a nitrogen- and a oxygen-based dianionic bis(chelating) ligand.

A “nitrogen-based bidentate ligand” refers to a ligand that is bonded to two transition metal atoms, and includes one or more heterocyclic or heteroaryl groups having one or more nitrogen atoms.

Referring to structure (V), a subset of rectangular supramolecules of this invention, in which M is Re; m can be 3; A is H₂-dhcd or H₂-Bim or H₂-BTA or H₂-dhnd or H₂-dhaq or H₂-dhnq; and I is diazine or a ligand of the formula:

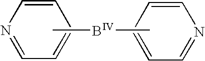

B^{IV} is a bond, alkyl, alkenyl, alkynyl, cyclyl, aryl, heterocyclyl, or heteroaryl; further, the two rings can be fused together with B^{IV} (not shown), e.g., diaza-anthracene or 1,6-Dihydro-benzo[lmn][3,8]phenanthroline. Examples of I include

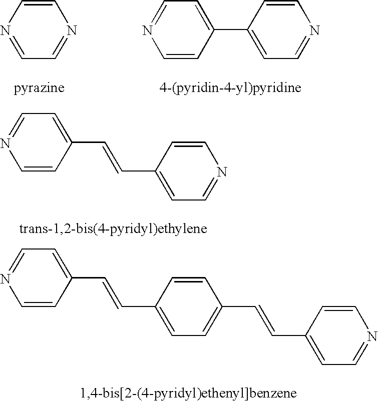

Additional examples of I are shown below:

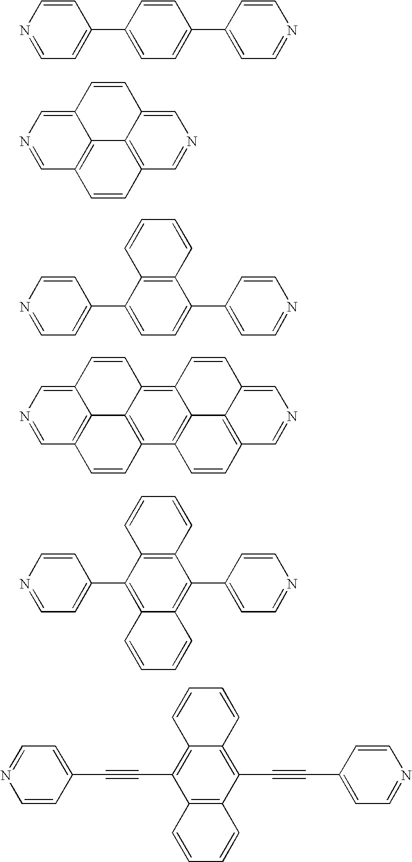

In another aspect, this invention features a trigonal prismatic supramolecule having the structure (VI):

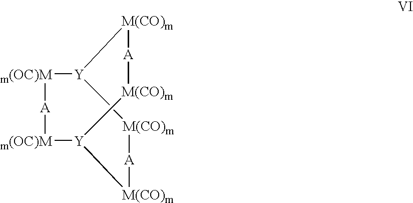

Here M is a transition metal atom that is rhenium (Re), manganese (Mn), chromium (Cr), molybdenum (Mo), tungsten (W), iron (Fe), ruthenium (Ru), or osmium (Os); Y is a nitrogen based tridentate ligand having 1200 bite angle; A is a dianionic bischelating-bridging unit. Other transition metal atoms may be utilized in accordance with the present invention as long as they, together with ligands, can form coordination complexes having the trigonal prismatic structures.

As used herein, the “orthogonal-bonding approach” to trigonal prismatic supramolecule structure refers to the simultaneous introduction of a bis(chelating) dianion to coordinate to two equatorial sites of fac-(CO)₃M cores and a tridentate nitrogen donor ligand to the remaining orthogonal axial site.

As used herein, the term “trigonal prismatic supramolecule” refers to a compound having six transition metal atoms connected in a trigonal prismatic cage-like geometry. Each of the transition metal atoms occupies one corner of the prism and is bonded to one nitrogen of a nitrogen-based tridentate ligand, i.e., Y in structure (VI) and is chelated to two oxygen atoms or two nitrogen atoms or a nitrogen- and a oxygen-based dianionic bis(chelating) ligand, i.e., A in structure (VI).

A “nitrogen-based tridentate ligand” refers to a ligand that is bonded to three transition metal atoms, and includes one or more heterocyclic or heteroaryl groups (e.g., triazine, pyrazole, imidazole, or pyridine) having one or more nitrogen atoms.

Referring to structure (VI), a subset of “trigonal prismatic supramolecules of this invention are those in which M is Re; m can be 3; A is H₂-dhcd or H₂-BBim or H₂-BTA or H₂-dhnd or H₂-dhaq or H₂-dhnq; and Y is triazine or a ligand of the formula:

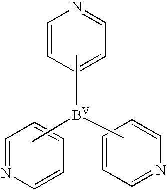

In the above formula, B^{V} is alkyl, alkenyl, alkynyl, cyclyl, aryl, heterocyclyl, or heteroaryl; further, the three rings can be fused together with B^{V} (not shown), e.g., triaza-triphenylene or triaza-trinaphthylene. An example of Y is 2,4,6-tri-4-pyridyl-1,3,5-triazine (referred to hereinafter as “tpt”).

Additional examples of Y are shown below:

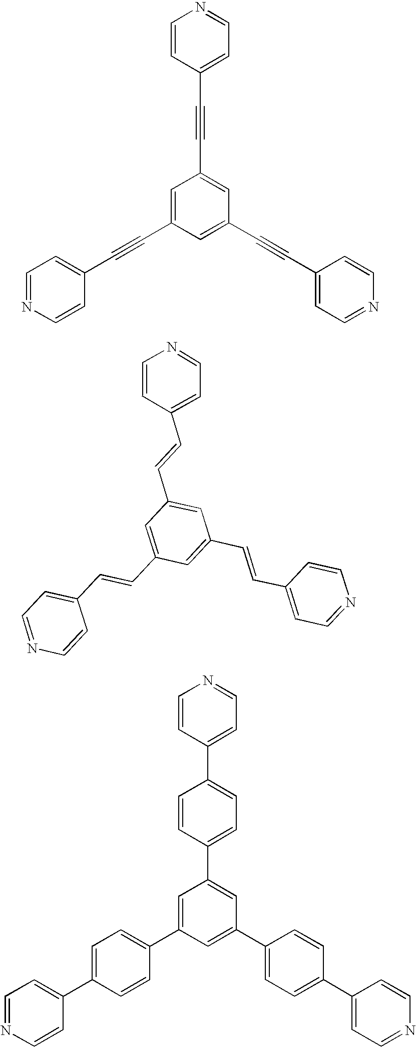

In another aspect, this invention features a hexagonal prismatic supramolecule having the structure (VII):

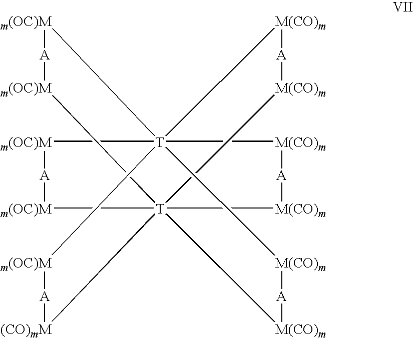

Here M is a transition metal atom that is rhenium (Re), manganese (Mn), chromium (Cr), molybdenum (Mo), tungsten (W), iron (Fe), ruthenium (Ru), or osmium (Os); T is a nitrogen based hexadentate ligand; A is a dianionic bischelating-bridging unit. Other transition metal atoms may be utilized in accordance with the present invention as long as they, together with ligands, can form coordination complexes having the trigonal prismatic structures.

As used herein, the “orthogonal-bonding approach” to hexagonal prismatic supramolecule structure or supramolecule refers to the simultaneous introduction of a bis(chelating) dianion to coordinate to two equatorial sites of fac-(CO)₃M cores and a tetradentate nitrogen donor ligand possessing 600 bite angle i.e., 60° between two coordinating nitrogen donor atoms, to the remaining orthogonal axial site.

As used herein, the term “hexagonal prismatic supramolecule” refers to a compound having twelve transition metal atoms connected in a hexagonal prismatic cage-like geometry. Each of the transition metal atoms occupies one corner of the prism and is bonded to one nitrogen of a nitrogen-based hexadentate ligand, i.e., T in structure (VII) and is chelated to two oxygen atoms or two nitrogen atoms of a nitrogen- or oxygen-based dianionic bis(chelating) ligand, i.e., A in structure (VII).

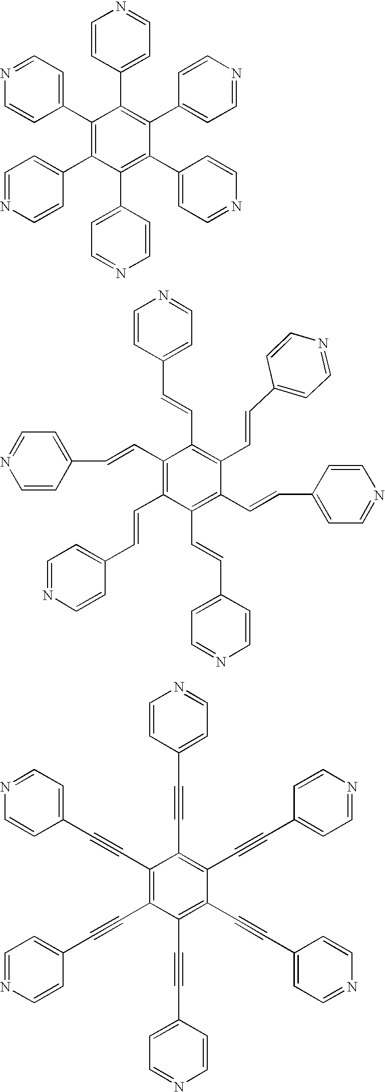

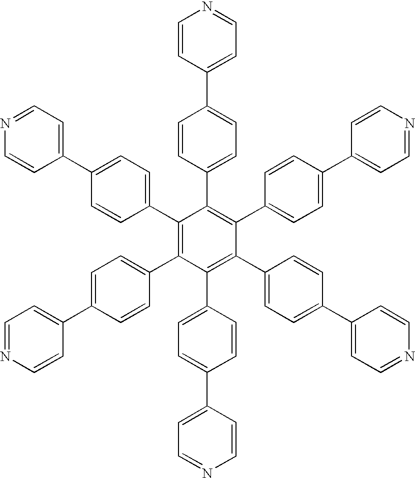

Alkyl, alkenyl, alkynyl, cyclyl, heterocyclyl, aryl, or heteroaryl (e.g., triazine, diazine, or pyridine) mentioned above include both substituted and unsubstituted moieties. As used herein, alkyl, alkenyl, alkynyl are straight or branched hydrocarbon chain. The term “substituted” refers to one or more substituents (which may be the same or different), each in replace of a hydrogen atom. Examples of substituents include, but are not limited to, halogen, hydroxyl, amino, cyano, nitro, C₂-C₆ alkenyl, C₂-C₆ alkynyl, aryl, heteroaryl, and heterocyclyl, wherein alkyl, alkenyl, alkoxy, aryl, heteroaryl, halogen, C₂-C₆ alkenyl, C₂-C₆ alkynyl, aryl, heteroaryl, and heterocyclyl, halogen, hydroxyl, amino, cyano, or nitro. The term “aryl” refers to a hydrocarbon ring system having at least one aromatic ring. Examples of aryl moieties include, but are not limited to, phenyl, naphthyl, and pyrenyl. The term “heteroaryl” refers to a hydrocarbon ring system having at least one aromatic ring which contains at least one heteroatom such as O, N, or S. Examples of heteroaryl moieties include, but are not limited to, pyridyl, carbozolyl, and indolyl.

### BRIEF DESCRIPTION OF THE DRAWINGS

In the drawings:

FIG. 1 shows a Ball and stick representation of the crystal structure of Compound 1. The hydrogen atoms are omitted for clarity.

FIG. 2 shows a ball and stick representation of the crystal structure of Compound 2. Atomic labelling with “A” represents equivalent atoms generated from symmetry code (−x+1, −y+1, −z+1). Solvent molecule and hydrogen atoms are omitted for clarity.

FIG. 3 shows schematically the self-assembly of metallacycles Compound 3, where R═H; and Compound 4, where R═OH.

FIG. 4 shows the crystal structure of the metallacycle 3; ball and stick representation (left); space-filling representation (right) with four methanol guests (shown in ball and stick model) occupied in the intramolecular cavity of Compound 3.

### DETAILED DESCRIPTION OF THE PRESENTLY PREFERRED EMBODIMENTS

The neutral rhenium-based molecular rectangles, gondolas, and inorganic calixarenes (bowls) of the present invention can be prepared by a one-pot synthesis via an orthogonal-bonding approach with excellent yields. They possess large cavities suitable for accommodating guest molecules. They are neutral, soluble, and very stable. These rectangles, gondolas, and inorganic calixarenes show size and shape selectivity towards aromatic guest molecules. Molecular rectangles are by far the best recognizing host for toxic benzene molecule. The gondola-shaped metallacycles are remarkable in terms of their structure, emitting property, multiple functional sites, and selective binding capability toward Hg²⁺ ion and planar aromatic compounds. The calix-shaped metallacycles possess tunable cavities and additional functional groups, which show molecular recognition capabilities. These gondolas, rectangles and bowls can find many applications in sensor and light-emitting devices.

There is no technology available that we know that provides a one-step preparation of neutral Re-based molecular rectangles, gondolas and inorganic calixarenes (bowls) possessing large cavities.

In one embodiment, Re₂(CO)₁₀, α,α′-bis(benzimidazol-1-yl)-o-xylene, and 2,2′-bisbenzimidazolyl were reacted in equimolar amounts to form Compound 1. In a second embodiment, when Re₂(CO)₁₀, α,α′-bis(benzimidazol-1-yl)-o-xylene and 6,11-dihydroxy-5,12-naphthacenedione were reacted in equimolar amounts to form Compound 2. Characterization of Compounds 1 and 2 are discussed in M. Sathiyendiran, et al., Dalton Transactions, p 1872-1874 (2007).

In a third embodiment, Re₂(CO)₁₀, 2,5-bis(5-tert-butyl-2-benzoxazolyl)thiophene, and 1,4-dihydroxy-9,10-anthraquinone were reacted in equimolar amounts to form Compound 3. In a fourth embodiment, Re₂(CO)₁₀, 2,5-bis(5-tert-butyl-2-benzoxazolyl)-thiophene, and 1,2,4-trishydroxy-9,10-anthraquinone were reacted to form Compound 4. Characterization of Compounds 3 and 4 are discussed in M. Sathiyendiran, et al., Inorganic Chemistry, vol. 45, No. 25, 10052-1054 (2006). It is noted that Compound 3 exhibits selective binding ability toward mercury cations and anthracene molecules.

### Example 1

In this study, α,α′-bis(benzimidazol-1-yl)-o-xylene (XyBim), 2,2′-bisbenzimidazolyl (H₂-Bim), and 6,11-dihydroxy-5,12-naphthacenedione (H₂-dhnq) were used as basic building units. In the case of XyBim, two benzimidazoles are connected via flexible methylene groups to an arene core. This flexibility permits XyBim to act as a ditopic molecular clip or Z-type connector.

Compound 1 was assembled by reacting equimolar amounts of Re₂(CO)₁₀, H₂-Bim, and XyBim in toluene. The resulting yellow products are air- and moisture-stable and are soluble in polar solvents. The IR spectrum of 1 exhibited strong bands at 2019 and 1908 cm⁻¹, characteristic of fac-Re(CO)₃. The FAB-MS analysis showed signals corresponding to a molecular ion at m/z=1110, with the experimental isotope pattern matching the calculated values. The ¹H NMR spectrum of 1 showed well-separated signals for the ligands. The H², H⁴-H⁸ proton signals in XyBim were shifted upfield, while H⁹-H¹⁰ were shifted downfield relative to those of the free ligand. Similarly, significant chemical shifts were observed for the Bim protons which show an upfield shift for H⁴, H⁷ and a downfield shift for H⁵-H⁶. In particular, the upfield shift observed for the benzimidazole and methylene protons of XyBim suggests that the two benzimidazole rings may maintain a face-to-face arrangement, thus shifting the proton signals upfield due to the ring current effect.

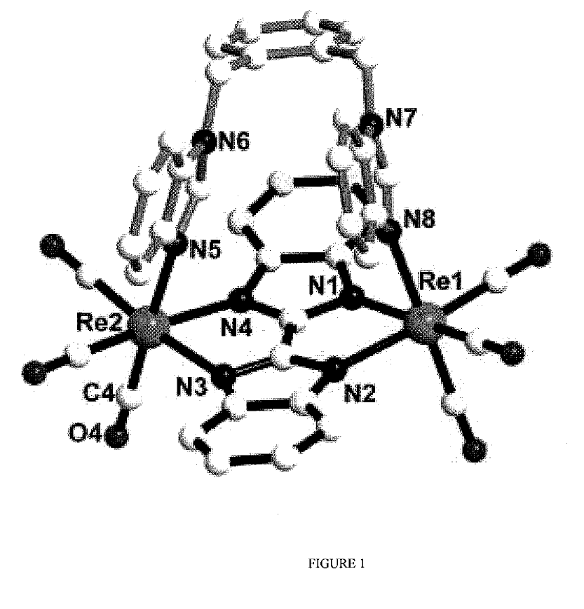

These results were confirmed by an X-ray crystallographic structure analysis, which revealed that compound 1 contains two fac-Re(CO)₃-cores, one Bim and one XyBim, as shown in FIG. 1. The coordination geometry around the Re centers is a distorted octahedral with a C₃N₃-donor environment. The dianionic Bim is coordinated in a symmetrical tetradentate manner through its four nitrogens to two rhenium centers. The Re-Re distance is 5.7 Å. The XyBim ligand adopts a syn-conformation mode, with both benzimidazole arms on the same side, and serve as a molecular clip. The distance of the two face-to-face parallel benzimidazole rings (dihedral angle=26.2°) ranges from 3.57 Å to 4.71 Å, suggesting a weak π . . . π stacking interaction. The phenylene plane is perpendicular to the two benzimidazole arms (dihedral angles, 84.5° and 70.7°) and almost parallel to the dianionic Bim plane. A similar arrangement of XyBim, i.e. a syn-conformation, was also observed in the case of Ag-XyBim complexes.

### Example 2

When the assembly unit was changed from H₂-Bim to H₂-dhnq with a large bridging length, and using the flexible linker XyBim, compound 2 was formed. The dark green product 2 is air and moisture-stable and insoluble. FAB-MS showed a molecular ion peak at m/z 2334.6.

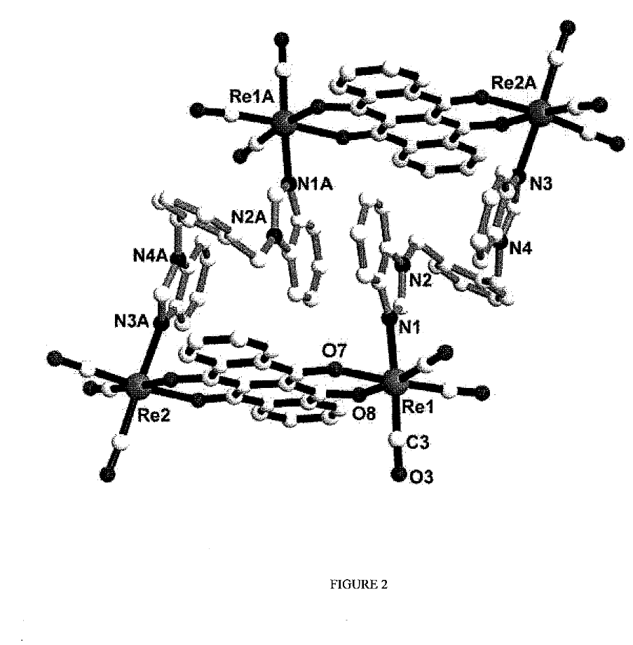

A single-crystal X-ray diffraction analysis showed that compound 2 (FIG. 2) adopts a tetrametallic metallacycle structure. The coordination geometry around the Re centers is a distorted octahedral with a C₃NO₂-donor environment. The dianionic dhnq acts as a doubly bridging unit using the adjacent phenolate and quinone oxygens. The Re-Re distance across the anionic-bridging unit is 8.6 Å, about 2.9 Å longer than those found in compound 1. The XyBim ligand adopts an anti-conformation mode, two benzimidazole arms are located on two sides, and serve as a “Z-type” bridging unit, utilizing the benzimidazoline-N atoms to bridge the bis-chelated dirhenium unit. The dihedral angle between the two benzimidazole rings of XyBim in 2 is 20.0°, comparable with those found in 1 (26.2°), but the coordination direction of the two nitrogens in 2 is opposite. The structure is stabilized by extensive inter-ligand π-π stacking interactions.

### Example 3

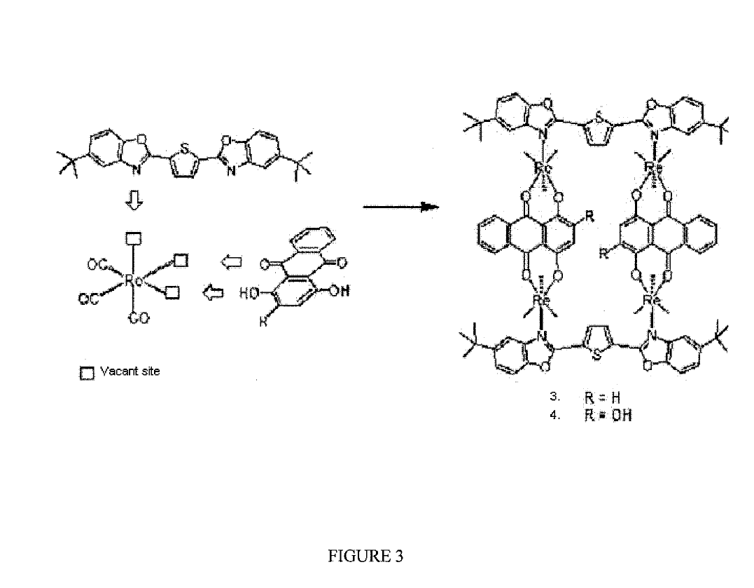

Herein we report on a new orthogonal-bonding approach for assembling functional molecules. This approach, which is an offshoot of the directional-bonding approach, involves the simultaneous introduction of a bis(chelating) dianion to coordinate to two equatorial sites of two fac-(CO)₃Re cores and a ditopic nitrogen-donor ligand to the remaining orthogonal axial site, leading to the generation of a new, hitherto unexplored class of metallacycles (FIG. 3).

2,5-bis(5-tert-butyl-2-benzoxazolyl)thiophene (tpbb) and 1,4-dihydroxy-9,10-anthraquinone (H₂-dhaq) or 1,2,4-trishydroxy-9,10-anthraquinone (H₂-thaq) were chosen for use as basic building units. The presence of two nitrogen donors should permit the tpbb ligand to act as a neutral bifunctional molecular clip. We rationalized that the use of the bischelating ligands H₂-dhaq and H₂-thaq would result in a macrocycle host with a large internal cavity. Although both ligands are important in dye chemistry, electroluminescent devices, biology, and pharmaceutical chemistry, their use as building units in the construction of supramolecular assemblies has not been previously investigated. The combination of the above-mentioned new building blocks and the novel orthogonal-bonding approach permits the preparation of unique gondola-shaped structures with crown-ether-like recognition sites, highly fluorescent properties, and selective binding capabilities. This approach is so effective that the products can be prepared in near quantitative yield.

The assembly of compounds 3 and 4 was achieved by reacting equimolar amounts of Re₂(CO)₁₀, tpbb, and H₂-dhaq or H₂-thaq in refluxing mesitylene. The resulting dark-green products were air and moisture stable and are slightly soluble in polar solvents. The IR spectrum of 3 in acetone exhibited strong bands at 2014 and 1900 cm⁻¹, characteristic of fac-Re(CO)₃. The ¹H NMR spectrum of 3 showed well-resolved signals for each of the protons. Compared to the free ligands, the signals corresponding to the tpbb protons remained nearly unchanged, while those of the dhaq proton of H² was shifted upfield by 0.16 ppm after complexation with the Re(I) centers. A similar pattern was observed for 4 with an additional singlet at 10.99 ppm corresponding to the uncoordinated hydroxyl hydrogen (C²—OH) atoms. The ESI-MS spectrum of 3 showed a molecular ion peak at m/z 2418.1.

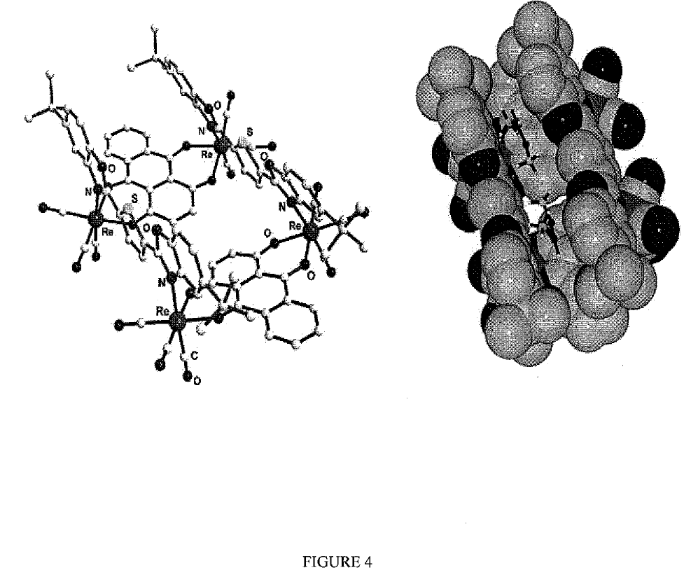

A single-crystal X-ray diffraction analysis shows that compound 3 adopts an unusual gondola-shaped structure (FIG. 4). The structure can be regarded as a special type of grid. The two tpbb ligands serve as molecular clips, utilizing the benzoxazoline N atoms to bridge two doubly bridged dirhenium units. The bishydroxy anthraquinone (dhaq) acts as a doubly bridging unit using the adjacent phenolate and quinone oxygens. Interestingly, the hydrophobic internal cavity of the metallacycle is sufficiently large (size: 5.6 Å×7.0 Å×17.8 Å) to accommodate four MeOH molecules. Compound 4 is isostructural with respect to 3 but contains two additional uncoordinated hydroxyl groups. It is noteworthy that compounds 3 and 4 possess multiple-recognition sites. The arrangement of heteroatoms may be considered as the structural framework of 1,10-dithio-(18crown-6) (see Supporting Information).

Compound 3 in CH₂Cl₂ displayed intense absorption bands in the 230-395 nm region, which are assigned to π-π* transitions of the dhaq and tpbb (357, 378, 397 nm) ligands, and a weak shoulder at 420 nm, assigned to the MLCT transition (Re→tpbb). In addition, weak absorption bands appeared at 585 and 632 nm, attributed to an intraligand transition of the dhaq unit. Compounds 3 and 4 show a high luminescence at room temperature with a quantum yield of 0.179 for 3 and 0.397 for 4 relative to Ru(bpy)₃²⁺. Upon excitation at λₘₐₓ=378 nm, compound 3 emits a set of structured bands centered at 438 nm with a lifetime of 1.4 ns. These emission bands are similar to that of the tpbb ligand. The small Stokes shift and very short lifetime of 3 indicate that the emission originates from the singlet π-π* excited state. In the solid state, compound 3 exhibits two emission maxima at 448 and 518 nm when excited at 335 nm. The emission band at 448 nm is due to the decay of the π-π* excited state of tpbb, while the band at 518 nm may be attributed to the decay of the d-π*Re tpbb excited state.

Studies were carried out on the host-guest chemistry of compound 3 using its absorption and luminescent features. The addition of metal ions such as Li^{I}, Sr^{II}, Co^{II}, Ni^{II}, Cu^{II}, Zn^{II}, Pb^{II}, and Ag^{I} did not show noticeable effects on the absorption and emission bands of 3. However, upon the addition of Hg^{II} ion, the absorption maximums of 3 at 357 and 378 nm decreased and a new absorption peak at 425 nm gradually became enhanced. Similarly, the emission maximum of 3 at 438 nm was quenched while the emission intensity at 490 nm gradually increased. A plot of 1/(ΔI) vs [G]⁻¹ at 495 nm showed a good linear relationship, indicating the formation of a 1:1 complex with a binding constant of 1.3×10³ M⁻¹. The binding constant did not change when different counterions (CF₃SO₃⁻, NO₃⁻) were used. The uncoordinated sulfur atoms of the tpbb ligands along with the flexibility of thiophene rings conferred by the σ-bond create a well-defined binding site for metal ion selective recognition. The adjacent hard (O atoms) Lewis base sites may exhibit a synergistic effect to strengthen the recognition capability. Another option is that each half of the macrocycle is occupied by one cation. Since the host/guest ratio is 1:1, the possibility that two macrocycles, with their cavities facing each other, are complexing two cations cannot be excluded. The emission enhancement of 3 may attributed to the chelation of metal ions thereby leading to more rigid complexes, which reduces the nonradiative decay process.

Furthermore, compound 3 was capable of specifically recognizing anthracene. Quenching of the emission intensity shows that 3 has a much higher affinity for anthracene (K=3.8×10³ M⁻¹) than pyrene, naphthalene, or benzene (K not detectable). The contribution of π systems would be very important for the binding of aromatic molecules, and the preference found for anthracene may result from shape complementarity with the anthraquinone moiety.

Additional exemplary compounds of the present invention are set forth below:

Compounds 3-4 having gondola structure (I), in which M is Re; m is 3; Π is tpbb; and A is

Compound 3: A=dhnq;
Compound 4: A=thnq.

Compounds 5-8 having calix-shaped structure (II), in which M is Re; m is 3; V is 4,7-phenanthroline.

Compound 5: A=tetq;
Compound 6: A=thaq;

### Compound 7: A=nq;

Compound 8: A=dhnq.

Compounds 9-14 having chair-like cage structure (IV), in which M is Re; m is 3;

Compound 9: A=dhnq; U=bix
Compound 10: A=dhnq; U=benzbix
Compound 11: A=dhaq; U=bix
Compound 12: A=dhaq; U=benzbix
Compound 13: A=thnq; U=bix
Compound 14: A=thnq; U=benzbix.

Compounds 15-18 having the rectangular supramolecule structure (V), in which M is Re; m is 3, I is bpy

Compound 15: A=tetq-Cl;

### Compound 16: A=nq;

Compound 17: A=dhaq;
Compound 18: A=dhnq.

In conclusion, a new class of neutral, luminescent metallacycles was designed and assembled in near quantitative yield using novel orthogonal-bonding strategy. The metallacycles are remarkable in terms of their structure, blue light-emitting property, multiple functional sites, and selective binding ability toward mercury cations and anthracene molecule. The orthogonal-bonding approach was found to be extremely effective toward the design of novel functional metallacycles.

The related art is listed below:
Benkstein, K. D.; Hupp, J. T.; Stern, C. L. J. Am. Chem. Soc. 1998, 120, 12982-12983.
Benkstein, K. D.; Hupp, J. T.; Stern, C. L. Angew. Chem. Int. Ed. 2000, 39, 2891-2893.
Rajendran, T.; Manimaran, B.; Lee, F. Y.; Lee, G. H.; Peng, S. M.; Wang, C. M.; Lu, K. L. Inorg. Chem. 2000, 39, 2016-2017.
Sathiyendiran, M.; Liao, R. T.; Thanasekaran, P.; Luo, T. T.; Venkataramanan, N. S.; Lee, G. H.; Peng, S. M.; Lu, K. L. Inorg. Chem. 2006, 45, 10052-10054.
Dinolfo, P. H.; Coropceanu, V.; Bredas, J.-L.; Hupp, J. T. J. Am. Chem. Soc. 2006, 128, 12592-12593.
Sathiyendiran, M.; Chang, C. H.; Chuang, C. H.; Luo, T. T.; Wen, Y. S.; Lu, K. L. Dalton Trans. 2007, 1872-1874.
Lu, K. L.; Rajendran, T.; Manimaran, B.; Lee, F. Y.; Wang, C. M.; Lee, G. H.; Peng, S. M. “Molecular Rectangles,” 2002, U.S. Pat. No. 6,455,693.
Lu, K. L.; Manimaran, B.; Rajendran, T.; Lee, G. H.; Peng, S. M.; Thanasekaran, P. “Prismatic Supramolecules,” 2005, U.S. Pat. No. 6,852,249 B2.
Lu, K. L.; Manimaran, B.; Rajendran, T.; Lu, Y. L.; Lee, G. H.; Peng, S. M. “Rectangular Supramolecules,” 2005, U.S. Pat. No. 6,965,028 B2

1. A process of making a metallacycle comprising the step of orthogonal bonding.

2. The process according to claim 1 comprising reacting Re₂(CO)₁₀, α,α′-bis(benzimidazol-1-yl)-o-xylene, and 2,2′-bisbenzimidazolyl.

3. The process according to claim 1 comprising reacting Re₂(CO)₁₀, α,α′-bis(benzimidazol-1-yl)-o-xylene, and 6,11-dihydroxy-5,12-naphthacenedione.

4. The process according to claim 1 comprising reacting Re₂(CO)₁₀, 2,5-bis(5-tert-butyl-2-benzoxazolyl)-thiophene, and 1,4-dihydroxy-9,10-anthraquinone.

5. The process according to claim 1 comprising reacting Re₂(CO)₁₀, 2,5-bis(5-tert-butyl-2-benzoxazolyl)-thiophene, and 1,2,4-trishydroxy-9,10-anthraquinone.

6. A metallacycle selected from the group consisting of Compound 1, Compound 2, Compound 3, and Compound 4.

7. A metallacycle selected from the group consisting of
a) a gondola-like structure I;
b) a calix-shaped structure II;
c) an octanuclear cage of structure III;
d) a chair-like structure IV;
e) a rectangular structure V;
f) a trigonal prismatic structure VI; and
g) a hexagonal prismatic structure VII.
